(19) United States
(12) Patent Application Publication
(10) Pub. No.: US 2020/0009791 A1
(43) Pub. Date: Jan. 9, 2020

(54) SMART HANDLING OF MATERIALS FOR THREE-DIMENSIONAL (3D) PRINTERS

(71) Applicant: SHIRIN LAKHANI, Lone Tree, CO (US)

(72) Inventor: SHIRIN LAKHANI, Lone Tree, CO (US)

(21) Appl. No.: 16/502,810

(22) Filed: Jul. 3, 2019

Related U.S. Application Data
(60) Provisional application No. 62/694,266, filed on Jul. 5, 2018.

(51) Int. Cl. B29C 64/357; B29C 64/314; B29C 64/264; B29C 64/393

(52) U.S. Cl. CPC B29C 64/357; B29C 64/314; B33Y 30/00; B29C 64/393; B29C 64/264

(57) ABSTRACT

A mechanism is described for facilitating smart handling of material for 3D printing. A method of embodiments, as described herein, includes facilitating receiving recyclable material through an input bin coupled to the 3D printing apparatus, where the recyclable material represents a first object used at least once. The method may further include disintegrating the recyclable material for recycling into a second object and printing the second object based on the recyclable material and placing the second object into an output bin.

### CLAIM OF PRIORITY

This application claims the benefit of and priority to U.S. Provisional Patent Application No. 62/694,266, entitled SMART HANDLING OF MATERIALS FOR THREE-DIMENSIONAL (3D) PRINTERS, by Shirin Lakhani, filed Jul. 5, 2018, the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

Embodiments described herein generally relate to devices. More particularly, embodiments relate to a smart handling of materials for three-dimensional (3D) printers.

### BACKGROUND

With the growth in 3D printing, it is becoming increasingly popular to use 3D printers to perform unconventional tasks. However, conventional techniques relating to 3D printing are still severely limited in their use, performance, and results.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates a computing device hosting a smart material handling mechanism according to one embodiment.

FIG. 2 illustrates the smart material handling mechanism of FIG. 1 according to one embodiment.

FIG. 3A illustrates a printing apparatus according to one embodiment.

FIG. 3B illustrates a printing apparatus according to one embodiment.

FIG. 3C illustrates a printing apparatus according to one embodiment.

FIG. 4 illustrates a method 400 for smart material handling for 3D printing according to one embodiment.

FIG. 5 illustrates an embodiment of an exemplary computing architecture that may be suitable for implementing various embodiments in accordance with some examples.

### DETAILED DESCRIPTION

In the following description, numerous specific details are set forth. However, embodiments, as described herein, may be practiced without these specific details. In other instances, well-known circuits, structures and techniques have not been shown in detail in order not to obscure the understanding of this description.

Embodiments provide for a novel technique for disintegration, storage, and recycling of materials for the purposes of 3D printing. For example, the technique provides for a novel apparatus or system that includes or is built on 3D printing technology by accepting material input in the form of ready-made products (as opposed to tubular filaments of material). In one embodiment, the novel apparatus/system is further to disintegrate a product that is composed of multiple varying materials using a disintegration technology (e.g., heat for plastics, one option is to use ascorbate vapor, which is currently used to polish finished 3D printed products, etc.). It is contemplated and to be noted that embodiments are not limited to any type of objects or products or their materials. For example, products being used or recycled or re-generated may include any range of objects ranging from household items (e.g., kitchen utensils, furniture, etc.) to personal items (e.g., watches, clothing, shoes, etc.) to machines (e.g., automobiles, microwaves, coffee machines, etc.) to military equipment (guns, tanks, etc.), sporting equipment (bats, balls, outfits, etc.), and/or the like.

Subsequently, in one embodiment, waste products are removed from the disintegrated materials and composted, while different material are transferred into individual storage containers, where, for example, each container is capable of holding varying materials, such as wood, steel, fabric, etc., such that they materials are kept separated. In one embodiment, such materials may be separated on a more granular basis, such as separating diverse types of plastic (e.g., separating polyethylene from terephthalate, etc.). Similarly, in some embodiments, materials may be separated based on any number and type of other factors, such as quality (e.g., separating high quality from low quality), age (e.g., separating new from old), cost (e.g., separating expensive from economical), frequency of use (e.g., separating frequently used from rarely used), and/or the like. It is contemplated or to be noted that embodiments are not limited to any given criteria or basis for separation and that the separation of materials may be predetermined and/or adjusted, on-demand, as desired or necessitated.

Further, for example, separated and liquefied materials in the storage containers may then be siphoned through filament tubes to 3D print at a 3D printer, where the liquefied material may not need to re-solidify into filaments prior to printing. For example, the use of a heating element in existing 3D printing technology is to melt the solid filaments while printing simultaneously. If the disintegrated materials contained in storage units are already in liquid form, none or very limited additional heating element may then be necessitated. Heat energy exerted during the disintegration process may be recovered and recycled to produce additional power for the 3D printing device.

It is contemplated that this novel technique, as described throughout this document, carries the potential to disrupt and enhance several industries, including household appliances, textiles (such as through 3D knitting machines), pottery, mobile devices, shoes, and various other product categories to which 3D printing combined with materials recycling technology is innovative and extremely useful. By way of example, a 3D printer that primarily prints porcelain (or related cookware materials) may be used to print any variety of dishes and cookery. For example, a consumer eats a meal using a dish or plate, and instead of washing it, places it back into the smart 3D printer or apparatus, which then melts the dish into its various material elements, removes waste products from the materials, and siphons the material elements into their respective dedicated storage units. When the consumer desires another dish to be printed, the 3D printer uses the recycled materials contained in the storage units to print a new dish, thereby eliminating wasted materials, excess storage space, and the need to continually repurchase 3D printing “ink”.

Embodiments further provide for a novel technique for application of patterns and/or designs to varying materials. For example, this novel apparatus by which a colorless filament receives an injection of color as the material is heated, liquefied, and 3D printed into the desired product.

Throughout this document, terms like “logic”, “component”, “module”, “framework”, “engine”, “mechanism”, “technique”, and/or the like, may be referenced interchangeably and include, by way of example, software, hardware, and/or any combination of software and hardware, such as firmware. Further, any use of a particular brand, word, term, phrase, name, acronym, or the like, such as “user”, “material”, “printer”, “3D printer”, “disintegration”, “storage”, “recycling”, “color”, “injection of color”, “heating”, “liquification”, “printing”, “wireless”, “computing device”, “smartphone”, “tablet computer”, “software application”, “social and/or business networking applications or websites”, “website”, or “site”, and/or the like, should not be read to limit embodiments to software or devices that carry that label in products or in literature external to this document.

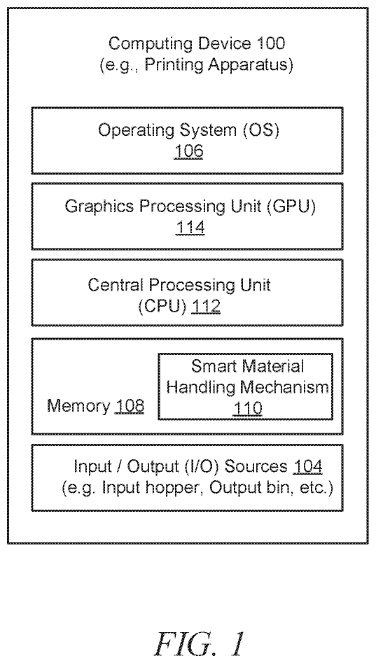

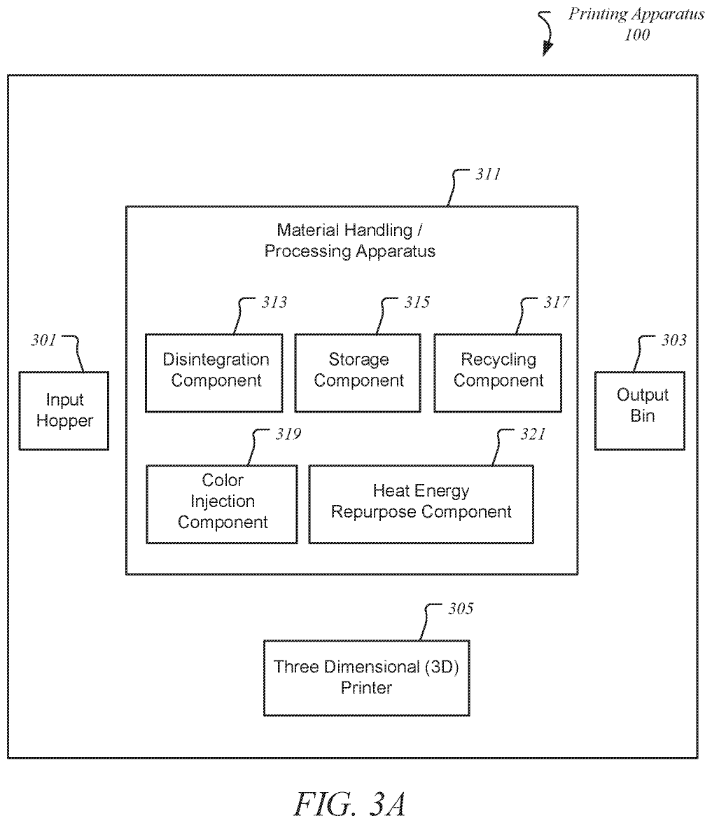

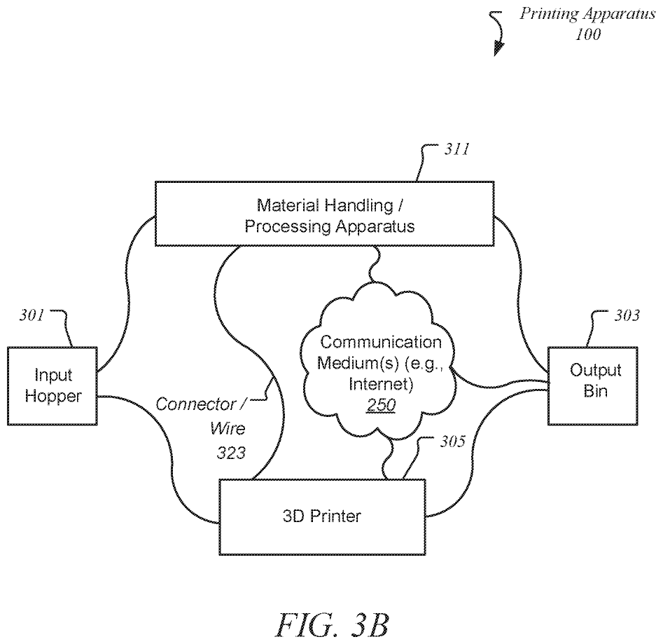

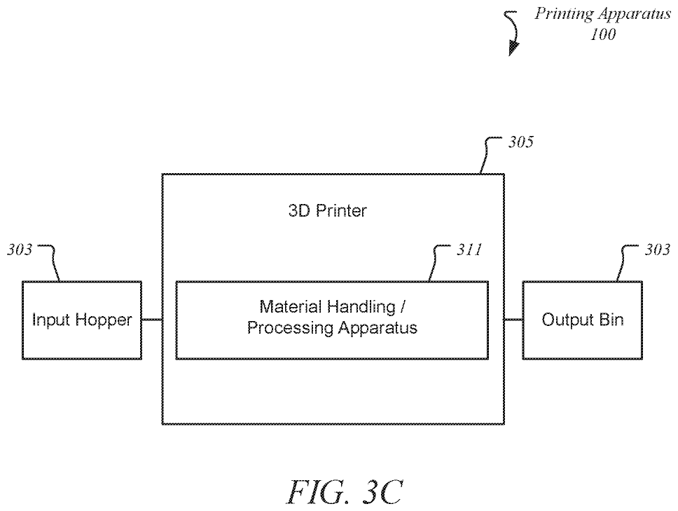

FIG. 1 illustrates a computing device 100 hosting smart material handling mechanism (“material mechanism”) 110 according to one embodiment. Computing or processing device (also referred to as “printing apparatus” or “printing system”) 100 represents a communication and data processing device that includes or is coupled to one or more 3D printers as will be further referenced with respect to FIGS. 3A-3C. Printing apparatus 100 represents a communication and data processing device that is capable of performing 3D printing of objects, where printing apparatus 100 may include or be associated with or facilitate (without limitation) one or more of smart voice command devices, intelligent personal assistants, home/office automation system, home appliances (e.g., washing machines, television sets, etc.), mobile devices (e.g., smartphones, tablet computers, etc.), gaming devices, handheld devices, wearable devices (e.g., smartwatches, smart bracelets, etc.), virtual reality (VR) devices, head-mounted displays (HMDs), Internet of Things (IoT) devices, laptop computers, desktop computers, server computers, set-top boxes (e.g., Internet-based cable television set-top boxes, etc.), global positioning system (GPS)-based devices, automotive infotainment devices, etc.

Further, printing apparatus 100 may include or be associated with or facilitate any number and type of other smart devices, such as (without limitation) autonomous machines or artificially intelligent agents, such as a mechanical agents or machines, electronics agents or machines, virtual agents or machines, electro-mechanical agents or machines, etc. Examples of autonomous machines or artificially intelligent agents may include (without limitation) robots, autonomous vehicles (e.g., self-driving cars, self-flying planes, self-sailing boats, etc.), autonomous equipment (self-operating construction vehicles, self-operating medical equipment, etc.), and/or the like. Further, “autonomous vehicles” are not limited to automobiles but that they may include any number and type of autonomous machines, such as robots, autonomous equipment, household autonomous devices, and/or the like, and any one or more tasks or operations relating to such autonomous machines may be interchangeably referenced with autonomous driving.

Further, for example, printing apparatus 100 may include a computer platform hosting an integrated circuit (“IC”), such as a system on a chip (“SoC” or “SOC”), integrating various hardware and/or software components of printing apparatus 100 on a single chip. For example, printing apparatus 100 comprises a data processing device having one or more processors including (but not limited to) central processing unit 112 and graphics processing unit 114 that are co-located on a common semiconductor package.

As illustrated, in one embodiment, printing apparatus 100 may include any number and type of hardware and/or software components, such as (without limitation) graphics processing unit (“GPU” or simply “graphics processor”) 114, graphics driver (also referred to as “GPU driver”, “graphics driver logic”, “driver logic”, user-mode driver (UMD), UMD, user-mode driver framework (UMDF), UMDF, or simply “driver”) 116, central processing unit (“CPU” or simply “application processor”) 112, memory 104, network devices, drivers, and/or the like, as well as input/output (I/O) source(s) 108, such as touchscreens, touch panels, touch pads, virtual or regular keyboards, virtual or regular mice, ports, connectors, etc. Printing apparatus 100 may include operating system (OS) 106 serving as an interface between hardware and/or physical resources of the printing apparatus 100 and a user.

It is to be appreciated that a lesser or more equipped system than the example described above may be preferred for certain implementations. Therefore, any configuration of printing apparatus 100 may vary from implementation to implementation depending upon numerous factors, such as price constraints, performance requirements, technological improvements, or other circumstances.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). Terms like “logic”, “module”, “component”, “engine”, “circuitry”, “element”, and “mechanism” may include, by way of example, software, hardware, firmware, and/or a combination thereof.

In one embodiment, as illustrated, material mechanism 110 may be hosted by memory 108 in communication with I/O source(s) 104, such as microphones, speakers, etc., of printing apparatus 100. In another embodiment, material mechanism 110 may be part of or hosted by operating system 106. In yet another embodiment, material mechanism 110 may be hosted or facilitated by graphics driver 116. In yet another embodiment, material mechanism 110 may be hosted by or embedded in central processing unit (“CPU” or simply “application processor”) 112 and/or graphics processing unit (“GPU” or simply graphics processor”) 114 as one or more hardware components, such as implemented by one or more analog or digital circuits, logic circuits, programmable processors, programmable controllers, GPUs, digital signal processors (DSPs), application specific integrated circuits (ASICs), programmable logic devices (PLDs), field programmable logic devices (FPLDs), and/or the like. It is, therefore, contemplated that one or more portions or components of material mechanism 110 may be employed or implemented as hardware, software, firmware, or any combination thereof.

In some embodiments, printing apparatus 100 includes a smart material handling component (“material component”) representing a hardware or firmware component hosted by one or more of application and graphics processors 112, 114. As will be further discussed in this document, in one embodiment, material component is facilitated by material mechanism 110 to perform one or more novels tasks as described throughout this document.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events

Printing apparatus 100 may host network interface device(s) to provide access to a network, such as a LAN, a wide area network (WAN), a metropolitan area network (MAN), a personal area network (PAN), Bluetooth, a cloud network, a mobile network (e.g., 3^{rd} Generation (3G), 4^{th} Generation (4G), etc.), an intranet, the Internet, etc. Network interface(s) may include, for example, a wireless network interface having antenna, which may represent one or more antenna(e). Network interface(s) may also include, for example, a wired network interface to communicate with remote devices via network cable, which may be, for example, an Ethernet cable, a coaxial cable, a fiber optic cable, a serial cable, or a parallel cable.

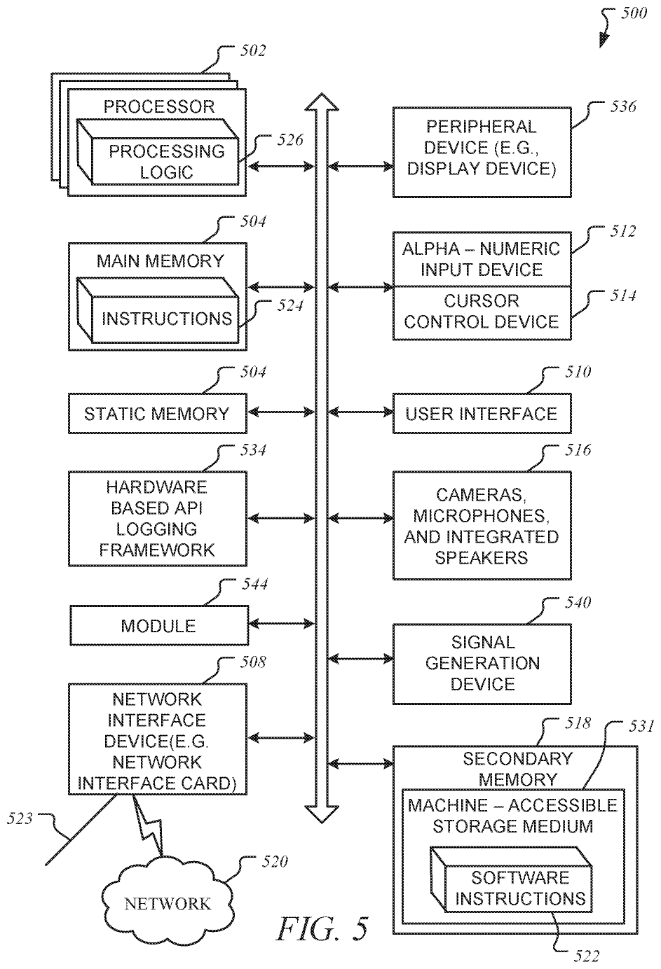

Embodiments may be provided, for example, as a computer program product which may include one or more machine-readable media having stored thereon machine-executable instructions that, when executed by one or more machines such as a computer, a data processing machine, a data processing device, network of computers, or other electronic devices, may result in the one or more machines carrying out operations in accordance with embodiments described herein. As further described with reference to processing architecture 500 of FIG. 5, a machine may include one or more processors, such as a CPU, a GPU, etc. A machine-readable medium may include, but is not limited to, floppy diskettes, optical disks, Compact Disc-Read Only Memories (CD-ROMs), magneto-optical disks, ROMs, Random Access Memories (RAMs), Erasable Programmable Read Only Memories (EPROMs), Electrically Erasable Programmable Read Only Memories (EEPROMs), magnetic or optical cards, flash memory, or other type of media/machine-readable medium suitable for storing machine-executable instructions.

For example, when reading any of the apparatus, method, or system claims of this patent to cover a purely software and/or firmware implementation, instructions associated with material mechanism 110 may be expressly stored at a non-transitory computer readable storage device or storage disk such as a memory, a digital versatile disk (DVD), a compact disk (CD), a Blu-ray disk, etc., including the software and/or firmware.

Moreover, one or more elements of material mechanism 110 may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

Throughout this document, the term “user” may be interchangeably referred to as “viewer”, “observer”, “speaker”, “person”, “individual”, “end-user”, “developer”, “programmer”, “administrators”, and/or the like. For example, in some cases, a user may refer to an end-user, such as a consumer accessing a client computing device, while, in some other cases, a user may include a developer, a programmer, a system administrator, etc., accessing a workstation serving as a client computing device. It is to be noted that throughout this document, terms like “graphics domain” may be referenced interchangeably with “graphics processing unit”, “graphics processor”, or simply “GPU”; similarly, “CPU domain” or “host domain” may be referenced interchangeably with “computer processing unit”, “application processor”, or simply “CPU”.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, and the like, may be used interchangeably throughout this document.

Further, throughout this document, terms like “request”, “query”, “job”, “work”, “work item”, and “workload” are referenced interchangeably. Similarly, an “application” or “agent” may refer to or include a computer program, a software application, a game, a workstation application, etc., offered through an application programming interface (API), such as a free rendering API, such as Open Graphics Library (OpenGL®), DirectX® 11, DirectX® 12, etc., where “dispatch” may be interchangeably referenced as “work unit” or “draw”, while “application” may be interchangeably referred to as “workflow” or simply “agent”.

In some embodiments, terms like “display screen” and “display surface” may be used interchangeably referring to the visible portion of a display device while the rest of the display device may be embedded into a computing device, such as a smartphone, a wearable device, etc. It is contemplated and to be noted that embodiments are not limited to any particular computing device, software application, hardware component, display device, display screen or surface, protocol, standard, etc. For example, embodiments may be applied to and used with any number and type of real-time applications on any number and type of computers, such as desktops, laptops, tablet computers, smartphones, head-mounted displays and other wearable devices, and/or the like. Further, for example, rendering scenarios for efficient performance using this novel technique may range from simple scenarios, such as desktop compositing, to complex scenarios, such as three-dimensional (3D) games, augmented reality applications, etc.

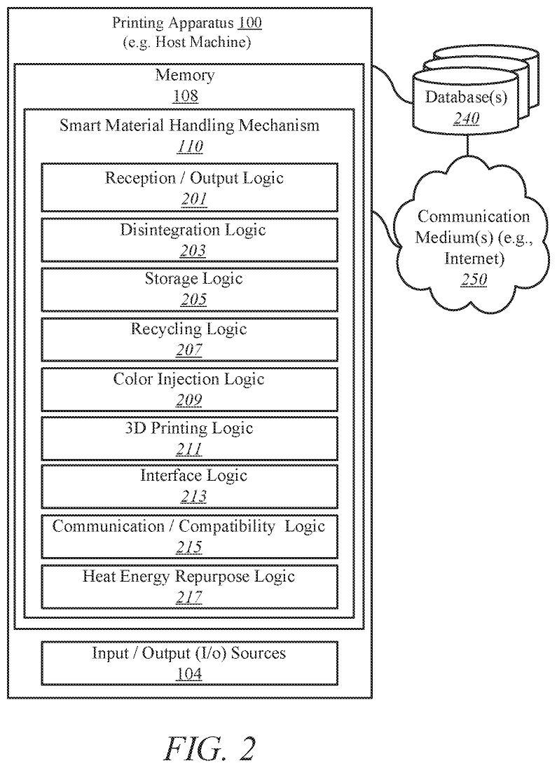

FIG. 2 illustrates material mechanism 110 of FIG. 1 according to one embodiment. For brevity, many of the details already discussed with reference to FIG. 1 are not repeated or discussed hereafter. Further, for brevity and clarity, many of the well-known processes and components associated with general or generic 3D printing and/or printing devices are not discussed in this document. In one embodiment, material mechanism 110 may include any number and type of components, such as (without limitations): reception/output logic 201; disintegration logic 203; storage logic 205; recycling logic 207; color injection logic 209; 3D printing logic 211; interface logic 213; communication/compatibility logic 215; and heat energy repurpose logic 217. Printing apparatus 100 is further shown as being in communication with one or more databases 240 and communication medium 250 (e.g., networks, such as cloud network, Internet, proximity network, etc.). For example, printing apparatus 100 may include a 3D printer or be in communication with one or more 3D printers directly or over communication medium(s) 250.

As previously discussed, reception/output logic 201 may be used to receive user requests for printing along with any material inputs of raw material for printing purposes in accordance with the requests. In one embodiment, disintegration logic 203 may be used to disintegrate the material for re-generation or recycling of the material into new products, as facilitated by recycling logic 207, to be printed using a 3D printer as facilitated by 3D printing logic 211, while storage logic 205 may be used for storage of new, used, and/or recycled material. In one embodiment, one or more 3D printers may be part of or in communication with printing apparatus 100. For example, reception/output logic 201 may be used to output the actual product printed by the 3D printer, when it is ready to be outputted.

In one embodiment, color injection logic 209 may be used to provide for patterns and/or designs, such as on clothing items, pottery, paintings, etc., by facilitating injection of colors on colorless filaments as the material is heated, liquefied, and 3D printed into the desired product. Further, in one embodiment, heat energy repurpose logic 217 may be used for repurposing or recycling of heat energy to perform any number and type of tasks, such as supplying power to various components or all of printing apparatus 100.

In one embodiment, interface logic 213 may be used to offer user interface to allow the user to input request, track the progress of the request, and anticipate outputs, change or edit previously-submitted requests, etc., through one or more user interfaces offered by one or more display screens or devices that are part of or in communication with printing apparatus 100.

As previously discussed, embodiments provide for a novel technique for disintegration, storage, and recycling of materials for the purposes of 3D printing. For example, the technique provides for a novel apparatus or system, such as printing apparatus 100, that includes or is built on 3D printing technology by accepting material input in the form of ready-made products (as opposed to tubular filaments of material). In one embodiment, this novel printing apparatus 100 is further to disintegrate a product that is composed of multiple varying materials using a disintegration technology (e.g., heat for plastics, one option is to use ascorbate vapor, which is currently used to polish finished 3D printed products, etc.).

Subsequently, in one embodiment, waste products are removed from the disintegrated materials and composted as facilitated by disintegration logic 203, while different material are transferred into individual storage containers for storage as facilitated by storage logic 205, where, for example, each container is capable of holding varying materials, such as wood, steel, fabric, etc., such that they materials are kept separated as further facilitated by storage logic 205. In one embodiment, such materials may be separated on a more granular basis, such as separating diverse types of plastic (e.g., separating polyethylene from terephthalate, etc.). Similarly, in some embodiments, materials may be separated based on any number and type of other factors, such as quality (e.g., separating high quality from low quality), age (e.g., separating new from old), cost (e.g., separating expensive from economical), frequency of use (e.g., separating frequently used from rarely used), and/or the like. It is contemplated or to be noted that embodiments are not limited to any given criteria or basis for separation and that the separation of materials may be predetermined and/or adjusted, on-demand, as desired or necessitated.

Further, for example, separated and liquefied materials in the storage containers may then be siphoned through filament tubes to 3D print at a 3D printer, where the liquefied material may not need to re-solidify into filaments prior to printing. For example, the use of a heating element in existing 3D printing technology is to melt the solid filaments while printing simultaneously as facilitated by 3D printing logic 211 and/or heat energy repurpose logic 217. If the disintegrated materials contained in storage units are already in liquid form, none or very limited additional heating element may then be necessitated. Heat energy exerted during the disintegration process may be recovered and recycled to produce additional power for the 3D printing device as facilitated by heat energy repurpose logic 217.

Further, for example, color injection logic 209 may be used to provide for patterns and/or designs, such as on clothing items, pottery, paintings, etc., by facilitating injection of colors on colorless filaments as the material is heated, liquefied, and 3D printed into the desired product. Further, in one embodiment, heat energy repurpose logic 217 may be used for repurposing or recycling of heat energy to perform any number and type of tasks, such as supplying power to various components or all of printing apparatus 100.

It is contemplated that this novel technique, as described throughout this document, carries the potential to improve upon the works of several industries, including household appliances, textiles (such as through 3D knitting machines), pottery, mobile devices, shoes, and various other product categories to which 3D printing combined with materials recycling technology is innovative and extremely useful. By way of example, a 3D printer that primarily prints porcelain (or related cookware materials) may be used to print any variety of dishes and cookery as facilitated by 3D printing logic 211. For example, a consumer eats a meal using a dish or plate, and instead of washing it, places it back into the smart 3D printer or apparatus, which then melts the dish into its various material elements, removes waste products from the materials, and siphons the material elements into their respective dedicated storage units as facilitated by recycling logic 207 and/or storage logic 205.

Now, for example, when the consumer desires another dish to be printed, the 3D printer uses the recycled materials contained in the storage units to print a new dish, thereby eliminating wasted materials, excess storage space, and the need to continually repurchase 3D printing “ink” as facilitated by a combination of storage logic 205, recycling logic 207, color injection logic 209, and 3D printing logic 211. Embodiments further provide for a novel technique for application of patterns and/or designs to varying materials. For example, a colorless filament receives an injection of color as the material is heated, liquefied, and 3D printed into the desired product as facilitated by color injection logic 209.

As discussed with reference to FIG. 1, various novel tasks as recited above may be facilitated by one or more components of material mechanism 110 in combination with a material component of one or more application processor 112 and graphics processor 114. For example, material mechanism 110 may facilitate a hardware/firmware-based material component and/or one or more other components of one or more of application and graphics processors 112, 114 to perform the various novel tasks as described throughout this document.

Further, any use of a particular brand, word, term, phrase, name, and/or acronym, such as “disintegration”, “storage”, “recycling”, “color injection”, “heating”, “liquifying”, “3D printing”, “3D printer”, “printing apparatus”, “material handling or processing apparatus”, “recycling or repurposing heat energy”, etc., should not be read to limit embodiments to software or devices that carry that label in products or in literature external to this document.

Communication/compatibility logic 215 may be used to facilitate the needed or desired communication and compatibility between any number of devices of and/or with printing apparatus 100 and/or various components of material mechanism 100. Some of the devices may include client or server computing devices, other printing apparatus, 3D printers, input/output devices (e.g., cameras, sensors, detectors, microphones, speakers, display devices, etc.), databases, networks, etc.

Communication/compatibility logic 215 may be used to facilitate dynamic communication and compatibility between various components, networks, database(s) 240, and/or communication medium(s) 250, etc., and any number and type of other computing devices (such as wearable computing devices, mobile computing devices, desktop computers, server computing devices, etc.), processing devices (e.g., central processing unit (CPU), graphics processing unit (GPU), etc.), capturing/sensing components (e.g., non-visual data sensors/detectors, such as audio sensors, olfactory sensors, haptic sensors, signal sensors, vibration sensors, chemicals detectors, radio wave detectors, force sensors, weather/temperature sensors, body/biometric sensors, scanners, etc., and visual data sensors/detectors, such as cameras, etc.), user/context-awareness components and/or identification/verification sensors/devices (such as biometric sensors/detectors, scanners, etc.), memory or storage devices, data sources, and/or database(s) (such as data storage devices, hard drives, solid-state drives, hard disks, memory cards or devices, memory circuits, etc.), network(s) (e.g., Cloud network, Internet, Internet of Things, intranet, cellular network, proximity networks, such as Bluetooth, Bluetooth low energy (BLE), Bluetooth Smart, Wi-Fi proximity, Radio Frequency Identification, Near Field Communication, Body Area Network, etc.), wireless or wired communications and relevant protocols (e.g., Wi-Fi®, WiMAX, Ethernet, etc.), connectivity and location management techniques, software applications/websites, (e.g., social and/or business networking websites, business applications, games and other entertainment applications, etc.), programming languages, etc., while ensuring compatibility with changing technologies, parameters, protocols, standards, etc.

Printing apparatus 100 may further provide a user interface (e.g., graphical user interface (GUI)-based user interface, Web browser, cloud-based platform user interface, software application-based user interface, other user or application programming interfaces (APIs), etc.) as facilitated by interface logic 213. Printing apparatus 100 may further include I/O source(s) 104 having input component(s), such as camera(s) (e.g., Intel® RealSense™ camera), microphone(s), sensors, detectors, keyboards, mice, etc., and output component(s), such as display device(s) or simply display(s) (e.g., integral displays, tensor displays, projection screens, display screens, etc.), speaker devices(s) or simply speaker(s), etc.

Printing apparatus 100 is further illustrated as having access to and/or being in communication with one or more database(s) 240 and/or one or more of other computing or printing devices over one or more communication medium(s) 250 (e.g., networks such as a proximity network, a cloud network, an intranet, the Internet, etc.).

In some embodiments, database(s) 240 may include one or more of storage mediums or devices, repositories, data sources, etc., having any amount and type of information, such as data, metadata, etc., relating to any number and type of applications, such as data and/or metadata relating to one or more users, physical locations or areas, applicable laws, policies and/or regulations, user preferences and/or profiles, security and/or authentication data, historical and/or preferred details, and/or the like.

As aforementioned, terms like “logic”, “module”, “component”, “engine”, “circuitry”, “element”, and “mechanism” may include, by way of example, software, hardware, firmware, and/or any combination thereof.

In one embodiment, I/O source(s) 104 may include one or more of containers, bins, hoppers, etc., to allow for reception and output of certain materials and objects. For example, reception/output logic 201 may facilitate a hopper or a bin of I/O source(s) 104 to accept the necessary raw material, such as glass, plastic, etc., and then upon processing the material through printing apparatus 100, as facilitated by material mechanism 110, the final product, such as a plate or a cup, etc., is outputted in a bit or an output container as facilitated by reception/output logic 201.

I/O source(s) 104 may further include any number or type of microphone(s), camera(s), speaker(s), display(s), etc., for capture or presentation of data. For example, as facilitated by reception/output logic 201, one or more of microphone(s) may be used to detect speech or sound simultaneously from users, such as speakers. Similarly, as facilitated by reception/output logic 201, one or more of camera(s) may be used to capture images or videos of a geographic location (whether that be indoors or outdoors) and its associated contents (e.g., furniture, electronic devices, humans, animals, trees, mountains, etc.) and form a set of images or video streams.

Similarly, as illustrated, output component(s) may include any number and type of speaker(s) or speaker device(s) to serve as output devices for outputting or giving out audio from printing apparatus 100 for any number or type of reasons, such as human hearing or consumption. For example, speaker(s) work the opposite of microphone(s) where speaker(s) 443 convert electric signals into sound.

Moreover, input component(s) may include any number or type of cameras, such as depth-sensing cameras or capturing devices that are known for capturing still and/or video red-green-blue (RGB) and/or RGB-depth (RGB-D) images for media, such as personal media. Such images, having depth information, have been effectively used for various computer vision and computational photography effects, such as (without limitations) scene understanding, refocusing, composition, cinema-graphs, etc. Similarly, for example, displays may include any number and type of displays, such as integral displays, tensor displays, stereoscopic displays, etc., including (but not limited to) embedded or connected display screens, display devices, projectors, etc.

Input component(s) may further include one or more of vibration components, tactile components, conductance elements, biometric sensors, chemical detectors, signal detectors, electroencephalography, functional near-infrared spectroscopy, wave detectors, force sensors (e.g., accelerometers), illuminators, eye-tracking or gaze-tracking system, head-tracking system, etc., that may be used for capturing any amount and type of visual data, such as images (e.g., photos, videos, movies, audio/video streams, etc.), and non-visual data, such as audio streams or signals (e.g., sound, noise, vibration, ultrasound, etc.), radio waves (e.g., wireless signals, such as wireless signals having data, metadata, signs, etc.), chemical changes or properties (e.g., humidity, body temperature, etc.), biometric readings (e.g., figure prints, etc.), brainwaves, brain circulation, environmental/weather conditions, maps, etc. It is contemplated that “sensor” and “detector” may be referenced interchangeably throughout this document. It is further contemplated that one or more input component(s) may further include one or more of supporting or supplemental devices for capturing and/or sensing of data, such as illuminators (e.g., IR illuminator), light fixtures, generators, sound blockers, etc.

It is further contemplated that in one embodiment, input component(s) may include any number and type of context sensors (e.g., linear accelerometer) for sensing or detecting any number and type of contexts (e.g., estimating horizon, linear acceleration, etc., relating to a mobile computing device, etc.). For example, input component(s) may include any number and type of sensors, such as (without limitations): accelerometers (e.g., linear accelerometer to measure linear acceleration, etc.); inertial devices (e.g., inertial accelerometers, inertial gyroscopes, micro-electro-mechanical systems (MEMS) gyroscopes, inertial navigators, etc.); and gravity gradiometers to study and measure variations in gravitation acceleration due to gravity, etc.

Similarly, output component(s) may include dynamic tactile touch screens having tactile effectors as an example of presenting visualization of touch, where an embodiment of such may be ultrasonic generators that can send signals in space which, when reaching, for example, human fingers can cause tactile sensation or like feeling on the fingers. Further, for example and in one embodiment, output component(s) may include (without limitation) one or more of light sources, display devices and/or screens, audio speakers, tactile components, conductance elements, bone conducting speakers, olfactory or smell visual and/or non/visual presentation devices, haptic or touch visual and/or non-visual presentation devices, animation display devices, biometric display devices, X-ray display devices, high-resolution displays, high-dynamic range displays, multi-view displays, and head-mounted displays (HMDs) for at least one of virtual reality (VR) and augmented reality (AR), etc.

It is contemplated that embodiment are not limited to any number or type of use-case scenarios, architectural placements, or component setups; however, for the sake of brevity and clarity, illustrations and descriptions are offered and discussed throughout this document for exemplary purposes but that embodiments are not limited as such. Further, throughout this document, “user” may refer to someone having access to one or more computing devices, such as printing apparatus 100, and may be referenced interchangeably with “person”, “individual”, “human”, “him”, “her”, “child”, “adult”, “viewer”, “player”, “gamer”, “developer”, programmer”, and/or the like.

Throughout this document, terms like “logic”, “component”, “module”, “framework”, “engine”, “tool”, “circuitry”, and/or the like, may be referenced interchangeably and include, by way of example, software, hardware, firmware, and/or any combination thereof. In one example, “logic” may refer to or include a software component that works with one or more of an operating system, a graphics driver, etc., of a computing device, such as printing apparatus 100. In another example, “logic” may refer to or include a hardware component that is capable of being physically installed along with or as part of one or more system hardware elements, such as an application processor, a graphics processor, etc., of a computing device, such as printing apparatus 100. In yet another embodiment, “logic” may refer to or include a firmware component that is capable of being part of system firmware, such as firmware of an application processor or a graphics processor, etc., of a computing device, such as printing apparatus 100.

Further, any use of a particular brand, word, term, phrase, name, and/or acronym, such as “3D printer”, “3D printing”, “printing device”, “printing apparatus”, “disintegrating”, “storing”, “recycling”, “color injecting”, “real-time”, “automatic”, “dynamic”, “user interface”, “camera”, “sensor”, “microphone”, “display screen”, “speaker”, “verification”, “authentication”, “privacy”, “user”, “user profile”, “user preference”, “sender”, “receiver”, “personal device”, “smart device”, “mobile computer”, “wearable device”, “IoT device”, “proximity network”, “cloud network”, “server computer”, etc., should not be read to limit embodiments to software or devices that carry that label in products or in literature external to this document.

It is contemplated that any number and type of components may be added to and/or removed from material mechanism 110 and/or a hardware/firmware-based material component to facilitate various embodiments including adding, removing, and/or enhancing certain features. For brevity, clarity, and ease of understanding of material mechanism 110, many of the standard and/or known components, such as those of a computing device are not shown or discussed here. It is contemplated that embodiments, as described herein, are not limited to any technology, topology, system, architecture, and/or standard and are dynamic enough to adopt and adapt to any future changes.

FIG. 3A illustrates printing apparatus 100 according to one embodiment. For brevity, many of the details already discussed with reference to FIGS. 1-2 are not repeated or discussed hereafter. Further, for brevity, many of the known processes and components associated with general 3D printing and/or 3D printers are not discussed in this document. Moreover, embodiments are not limited to any type or order of placement of components or flow of processes and thus embodiments are not limited or restricted to the illustration of FIG. 2.

As illustrated, in one embodiment, printing apparatus 100 may include material handling/processing apparatus (“material apparatus”) 311 that is facilitated by material mechanism 110 of FIG. 1. For example, material apparatus 311 may include: disintegration component 313 as facilitated by disintegration logic 203; storage component 315 as facilitated by storage logic 205; recycling component 317 as facilitated by recycling logic 207; color injection component 319 as facilitated by color injection logic 209; and heat energy repurpose component 321 as facilitated by heat energy repurpose logic 217.

In the illustrated embodiment, as further discussed with reference to FIG. 2, printing apparatus 100 further includes 3D printer 305, input hopper 301 to receive material (e.g., raw material), and output bin 303 to output final products (e.g., printed material).

FIG. 3B illustrates printing apparatus 100 according to one embodiment. For brevity, many of the details already discussed with reference to FIGS. 1-3A are not repeated or discussed hereafter. Further, for brevity, many of the known processes and components associated with general 3D printing and/or 3D printers are not discussed in this document. Moreover, embodiments are not limited to any type or order of placement of components or flow of processes and thus embodiments are not limited or restricted to the illustration of FIG. 3A.

In this embodiment, as illustrated, material apparatus 311 and 3D printer 305 might be separate devices that in put in communication either directly, such as using wire or connector 323, or wirelessly through communication medium 250, such as one or more networks, such as a cloud network, the Internet, etc. Similarly, input hopper 301 and output bin 303 may be in communication, directly or wirelessly, with one or more of material apparatus 311 and 3D printer 305.

FIG. 3C illustrates printing apparatus 100 according to one embodiment. For brevity, many of the details already discussed with reference to FIGS. 1-3B are not repeated or discussed hereafter. Further, for brevity, many of the known processes and components associated with general 3D printing and/or 3D printers are not discussed in this document. Moreover, embodiments are not limited to any type or order of placement of components or flow of processes and thus embodiments are not limited or restricted to the illustration of FIG. 3B.

In this illustrated embodiment, material apparatus 311 is shown as being part of or hosted by 3D printer 305, while input hopper 301 and output bin 303 are shown as being in communication with 3D printer 305.

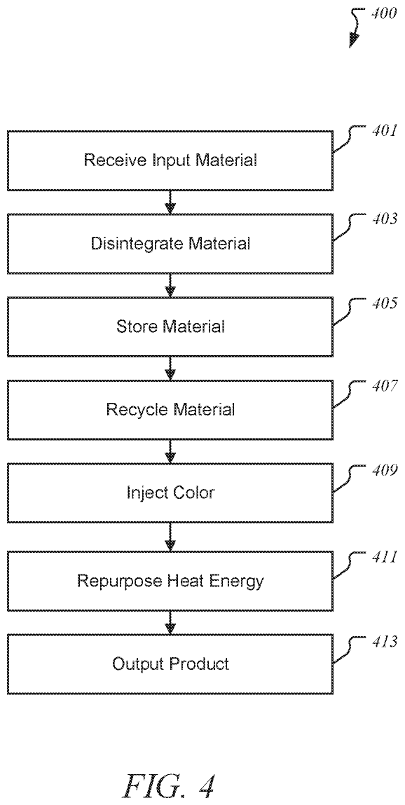

FIG. 4 illustrates a method 400 for smart material handling for 3D printing according to one embodiment. For brevity, many of the details previously discussed with reference to FIGS. 1-3C may not be discussed or repeated hereafter. Further, for brevity, many of the known processes and components associated with general 3D printing and/or 3D printers are not discussed in this document. Any processes relating to this method 400 may be performed by processing logic that may comprise hardware (e.g., circuitry, dedicated logic, programmable logic, etc.), software (such as instructions run on a processing device), or a combination thereof, as facilitated by material mechanism 110 of FIG. 1. The processes associated with this method 400 may be illustrated or recited in linear sequences for brevity and clarity in presentation; however, it is contemplated that any number of them can be performed in parallel, asynchronously, or in different orders.

As previously discussed with reference to FIG. 2, method 400 begins at block 401 with receiving of inputted material (e.g., raw material, recyclable material, etc.) in an input hopper of printing apparatus 100 of FIG. 1 as facilitated reception/output logic 201 of FIG. 2, followed by disintegration of the inputted material at block 403 as facilitated by disintegration logic 203 of FIG. 2. At block 405, some of the material, such as material that is usable or may be used to form a final printing object or product, is stored as facilitated by storage logic 205 of FIG. 2, while at block 407, other material, such as material that is recyclable but not usable in its current form, is recycled as facilitated by recycling material 207 of FIG. 2. At block 409, in one embodiment, color in injected on material, such as colorless filament, as facilitated by color injection logic 209 of FIG. 2. At block 411, heat energy is repurposed or recycled to perform certain operations, such as supplying power to all or one or more components of the printing apparatus, s facilitated by heat energy repurpose logic 217 of FIG. 2. At block 413, a final product is outputted in an output bin for the user to pick up and use as facilitated by reception/output logic 201.

FIG. 5 illustrates a diagrammatic representation of a machine 500 in the exemplary form of a computer system, in accordance with one embodiment, within which a set of instructions, for causing machine 500 to perform any one or more of the methodologies discussed herein, may be executed. Machine 500 may be the same as or similar to or contained within or include printing apparatus 100 of FIG. 1 to perform or execute one or more methodologies discussed throughout this document. In alternative embodiments, machine 500 may be connected (e.g., networked) to other machines either directly, such as via media slot or over a network, such as a cloud-based network, a Local Area Network (LAN), a Wide Area Network (WAN), a Metropolitan Area Network (MAN), a Personal Area Network (PAN), an intranet, an extranet, or the Internet. The machine may operate in the capacity of a server or a client machine in a client-server network environment, or as a peer machine in a peer-to-peer (or distributed) network environment or as a server or series of servers within an on-demand service environment, including an on-demand environment providing multi-tenant database storage services. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 500 includes one or more processors 502, a main memory 504 (e.g., read-only memory (ROM), flash memory, dynamic random access memory (DRAM) such as synchronous DRAM (SDRAM) or Rambus DRAM (RDRAM), etc., static memory 542, such as flash memory, static random access memory (SRAM), volatile but high-data rate RAM, etc.), and a secondary memory 518 (e.g., a persistent storage device including hard disk drives and persistent multi-tenant data base implementations), which communicate with each other via a bus 530. Main memory 504 includes instructions 524 (such as software 522 on which is stored one or more sets of instructions 524 embodying any one or more of the methodologies or functions of material mechanism 110 of computing device 100 of FIG. 1 and other figures described herein) which operate in conjunction with processing logic 526 and processor 502 to perform the methodologies discussed herein.

Processor 502 represents one or more general-purpose processing devices such as a microprocessor, central processing unit, or the like. More particularly, the processor 502 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 502 may also be one or more special-purpose processing devices such as an application specific integrated circuit (ASIC), a field programmable gate array (FPGA), a digital signal processor (DSP), network processor, or the like. Processor 502 is configured to execute the processing logic 526 for performing the operations and functionality of material mechanism 110 of computing device 100 of FIG. 1 and other figures discussed herein.

The computer system 500 may further include a network interface device 508, such as a network interface card (NIC). The computer system 500 also may include a user interface 510 (such as a video display unit, a liquid crystal display (LCD), or a cathode ray tube (CRT)), an alphanumeric input device 512 (e.g., a keyboard), a cursor control device 514 (e.g., a mouse), a signal generation device 540 (e.g., an integrated speaker), and other devices 516 like cameras, microphones, integrated speakers, etc. The computer system 500 may further include peripheral device 536 (e.g., wireless or wired communication devices, memory devices, storage devices, audio processing devices, video processing devices, display devices, etc.). The computer system 500 may further include a hardware-based application programming interface logging framework 534 capable of executing incoming requests for services and emitting execution data responsive to the fulfillment of such incoming requests.

Network interface device 508 may also include, for example, a wired network interface to communicate with remote devices via network cable 523, which may be, for example, an Ethernet cable, a coaxial cable, a fiber optic cable, a serial cable, a parallel cable, etc. Network interface device 508 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported. In addition to, or instead of, communication via the wireless LAN standards, network interface device 508 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

The secondary memory 518 may include a machine-readable storage medium (or more specifically a machine-accessible storage medium) 531 on which is stored one or more sets of instructions (e.g., software 522) embodying any one or more of the methodologies or functions of material mechanism 110 of FIG. 1 and other figures described herein. The software 522 may also reside, completely or at least partially, within the main memory 504, such as instructions 524, and/or within the processor 502 during execution thereof by the computer system 500, the main memory 504 and the processor 502 also constituting machine-readable storage media. The software 522 may further be transmitted or received over network 520 via the network interface card 508. The machine-readable storage medium 531 may include transitory or non-transitory machine-readable storage media.

Portions of various embodiments may be provided as a computer program product, which may include a computer-readable medium having stored thereon computer program instructions, which may be used to program a computer (or other electronic devices) to perform a process according to the embodiments. The machine-readable medium may include, but is not limited to, floppy diskettes, optical disks, compact disk read-only memory (CD-ROM), and magneto-optical disks, ROM, RAM, erasable programmable read-only memory (EPROM), electrically EPROM (EEPROM), magnet or optical cards, flash memory, or other type of media/machine-readable medium suitable for storing electronic instructions.

Modules 544 relating to and/or include components and other features described herein (for example in relation to material mechanism 110 of computing device 100 as described with reference to FIG. 1) can be implemented as discrete hardware components or integrated in the functionality of hardware components such as ASICS, FPGAs, DSPs or similar devices. In addition, modules 544 can be implemented as firmware or functional circuitry within hardware devices. Further, modules 544 can be implemented in any combination hardware devices and software components.

The techniques shown in the figures can be implemented using code and data stored and executed on one or more electronic devices (e.g., an end station, a network element). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. Of course, one or more parts of an embodiment may be implemented using different combinations of software, firmware, and/or hardware.

Any of the above embodiments may be used alone or together with one another in any combination. Embodiments encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements. It is to be understood that the above description is intended to be illustrative, and not restrictive.

What is claimed is:

1. A three-dimensional (3D) printing apparatus comprises:
one or more processors to:
receive recyclable material through an input bin coupled to the 3D printing apparatus, wherein the recyclable material represents a first object used at least once;
disintegrate the recyclable material for recycling into a second object; and
printing the second object based on the recyclable material and placing the second object into an output bin.

2. The printing apparatus of claim 1, wherein one or more processors are further to store a portion of the recyclable material that is unnecessary or incapable of being used for the second object, wherein the first portion is used for printing other objects.

3. The printing apparatus of claim 1, wherein the one or more processors are further to inject color into the recyclable material such that the second object includes one or more filaments of colors.

4. The printing apparatus of claim 1, wherein the one or more processors are further to repurposed power supply heat energy into the recyclable material such that second object is formed in one or more shapes and one or more textures of the first object.

5. The printing apparatus of claim 1, wherein the first and second objects comprise one or more of household items, outdoor items, personal items, machines, military equipment, and sporting equipment.

6. A method comprises:
receiving recyclable material through an input bin coupled to the 3D printing apparatus, wherein the recyclable material represents a first object used at least once;
disintegrating the recyclable material for recycling into a second object; and
printing the second object based on the recyclable material and placing the second object into an output bin.

7. The method of claim 6, further comprising storing a portion of the recyclable material that is unnecessary or incapable of being used for the second object, wherein the first portion is used for printing other objects.

8. The method of claim 6, further comprising injecting color into the recyclable material such that the second object includes one or more filaments of colors.

9. The method of claim 6, further comprising repurposing power supply heat energy into the recyclable material such that second object is formed in one or more shapes and one or more textures of the first object.

10. The method of claim 6, wherein the first and second objects comprise one or more of household items, outdoor items, personal items, machines, military equipment, and sporting equipment.

11. At least one machine-readable medium having stored thereon instructions which when executed by a processing device, causes the processing device to perform operations comprising:
receiving recyclable material through an input bin coupled to the 3D printing apparatus, wherein the recyclable material represents a first object used at least once;
disintegrating the recyclable material for recycling into a second object; and
printing the second object based on the recyclable material and placing the second object into an output bin.

12. The machine-readable medium of claim 11, wherein the operations further comprise storing a portion of the recyclable material that is unnecessary or incapable of being used for the second object, wherein the first portion is used for printing other objects.

13. The machine-readable medium of claim 11, wherein the operations further comprise injecting color into the recyclable material such that the second object includes one or more filaments of colors.

14. The machine-readable medium of claim 11, wherein the operations further comprise repurposing power supply heat energy into the recyclable material such that second object is formed in one or more shapes and one or more textures of the first object.

15. The machine-readable medium of claim 11, wherein the first and second objects comprise one or more of household items, outdoor items, personal items, machines, military equipment, and sporting equipment.
